(19) United States
(12) Patent Application Publication
(10) Pub. No.: US 2011/0154200 A1
(43) Pub. Date: Jun. 23, 2011

(54) Enhancing Media Content with Content-Aware Resources

(75) Inventors: Daniel Davis, San Francisco, CA (US); G. Garrett Groszko, Oakland, CA (US); Alan Cannistraro, San Francisco, CA (US)

(73) Assignee: Apple Inc.

(21) Appl. No.: 12/646,870

(22) Filed: Dec. 23, 2009

(51) Int. Cl. H04N 7/087; G06F 3/048; G06F 3/01

(52) U.S. Cl. 715/716; 715/765

(57) ABSTRACT

Methods, systems, and computer program products for making enhanced media content available to a viewer of a media device may include receiving data packets via a packet-switched network, the received data packets including (i) media content for presentation to a user, (ii) location data specifying a resource that is complementary to the media content, and (iii) state data relating to a state of the complementary resource; determining, based at least in part on the received state data, whether the state of the complementary resource is to be changed; and based on a result of the determination, selectively performing operations including using the received location data to communicate with, and retrieve complementary content from, the complementary resource; and presenting the complementary content to the user in synchronization with the media content.

### BACKGROUND

This disclosure relates to enhancing the presentation of media content (e.g., video and audio) with content-aware resources.

In the realm of computer software operating systems and application programs, light-weight, single-purpose applications referred to as “widgets” or “gadgets” have gained some prominence as useful resources with which users can interact to obtain information (e.g., weather, stock ticker values), perform a particular function (e.g., desktop calculator, web search interface) or interact with others (e.g., send messages back and forth among friends on a social networking website). Apple Inc., for example, provides an environment known as “Dashboard” that enables users to choose from among a wide assortment of widgets, which can be installed and execute locally on a user's computer. Generally speaking, the basic components of a widget include a graphical user interface (GUI) for communicating with a user and a single-purpose functionality that responds to user input and which represents an available resource. The types and functionality of such widgets are limited largely only by the widget developer's creativity.

Recently, a few consumer electronics companies have extended the widget paradigm to television (TV). For example, while watching TV programming on a widget-enabled TV set, the viewer can manipulate the TV remote control to interact, for example, with a “chat” widget displayed on the TV screen to send text messages back and forth with others connected to a common chat network.

### SUMMARY

The present inventors recognized a limitation of existing widget technology as applied to TV environment in that conventional widgets, while often useful resources standing alone, nevertheless are unaware of the media content that the TV set was currently presenting. For example, such conventional TV widgets are unaware of what particular television program the user is presently watching on the TV. Accordingly, the present inventors envisioned and developed an enhanced TV widget paradigm in which widgets are capable of being content-aware and thus capable, among other things, of automatically (i.e., without intervening user input) providing the user with access to information or other resources that are complementary or otherwise relevant to the media content currently being presented by the TV set to the user.

In general, in one aspect, the subject matter can be implemented to include methods, systems, and apparatus for making enhanced media content available to a viewer of a media device in which data packets are received via a packet-switched network, the received data packets including (i) media content for presentation to a user, (ii) location data specifying a resource that is complementary to the media content, and (iii) state data relating to a state of the complementary resource (e.g., corresponding to one or more of the following states: visibility/invisibility, activate/deactivate, change functionality, change appearance, and change position); based at least in part on the received state data, a determination is made whether the state of the complementary resource is to be changed; and based on a result of the determination, operations are selectively performed including using the received location data to communicate with, and retrieve complementary content from, the complementary resource; and presenting the complementary content to the user in synchronization with the media content.

In general, in an aspect, methods, systems, and computer program products for making enhanced media content available to a viewer of a media device may include receiving data packets via a packet-switched network, the received data packets including (i) media content for presentation to a user, (ii) location data specifying a resource that is complementary to the media content, and (iii) state data relating to a state of the complementary resource; determining, based at least in part on the received state data, whether the state of the complementary resource is to be changed; and based on a result of the determination, selectively performing operations including using the received location data to communicate with, and retrieve complementary content from, the complementary resource; and presenting the complementary content to the user in synchronization with the media content, optionally also formatting the received information based on an output device with which the user is accessing the media content.

In addition, input may be received from the user relating to a requested interaction with the complementary resource, in which case the received input may be delivered to the complementary resource. Information may then be received from the complementary resource responsive to the received user input, and presented to the received information to the user.

Further user input specifying a second resource of the user's choosing may be received and used to retrieve second content from the second resource based on location information corresponding to the second resource. The retrieved second content may be formatted relative to the media content and relative to the complementary content, and the formatted second content, the complementary resource and media content may be presented to the user.

The data packets received may further include one or more markers identifying one or more events that trigger communication with the complementary resource or the user or both. Such markers may be presented to the user and the user may be enabled to interact with the tags to alter one or more of timing, behavior and complementary content.

The user may be presented with one or more user interface mechanisms to enable the user to modify behavior of a complementary resource, to access an online repository of complementary resources available for download, and/or to enable the user to generate complementary resources.

In another aspect, an enhanced media content development system includes a computer system having a processor, memory, and input and output devices. An application configured to execute on the computer system may enable a user of the computer system to build an item of enhanced media content by specifying complementary resources that will be presented to an audience member along with an item of primary media content. The application may include a user interface configured to provide a user of the enhanced media content development system with mechanisms to synchronize one or more complementary resources with corresponding portions of the item of primary media content. The application may be configured to generate an enhanced media file that includes the primary media content and metadata specifying locations at which the one or more complementary resources are to be accessed by a media presentation device when the corresponding portions of the primary media content item are being presented to the audience member.

The user interface may further be configured to provide the user of the enhanced content development system with one or more mechanisms to synchronize one or more events with corresponding portions of the item of primary media content.

The user interface may include a film strip region that provides the user with access to the primary media content item, a complementary resource region that provides the user with access to one or more complementary resources available for synchronization with the primary media content item, an event region that provides the user with access to one or more events available for synchronization with the primary media content item, and a timeline region that enables the user to synchronize one or more of the complementary resources with corresponding portions of the item of primary media content. The timeline region may include a plurality of individual timelines each of which corresponds to a different presentation platform for which the enhanced media file is optimized.

The subject matter described in this specification can be implemented to realize one or more of the following potential advantages. For example, the subject matter can be implemented to create an enhanced and richer TV viewing experience in which complementary resources (e.g., background information, webpages, supplemental media content, executable applications, utilities and the like) that are guaranteed to be relevant to the media content being presented can be caused to automatically appear on the user's TV screen at an appropriate time and/or in synchronization with presentation of the media content. Similarly, these same resources can be caused to automatically disappear when they are no longer relevant or useful based on the currently presented portion of the media content, thereby minimizing confusion and screen clutter. As a result, the user will tend to have a more enjoyable and fulfilling viewing experience and will be spared the trouble of having to manually locate and access resources that may or may not be relevant to the content presently being presented.

The details of one or more implementations are set forth in the accompanying drawings and the description below. Other features and potential advantages will be apparent from the description and drawings, and from the claims.

### BRIEF DESCRIPTION OF THE DRAWINGS

FIG. 1 is an example of a media system including a media client.

FIG. 2 is an example of a TV set displaying media content with widget overlays.

FIG. 3 is a mockup of an example user interface that could be used to synchronize widgets with media content.

FIG. 4 is a flowchart of a process for synchronizing widgets with media content.

FIG. 5. Is a flowchart of a process for using content-aware widgets to present complementary resources to a viewer in synchronization with presentation of media content.

FIG. 6 is an example of a media client architecture.

Like reference symbols indicate like elements throughout the specification and drawings.

### DETAILED DESCRIPTION

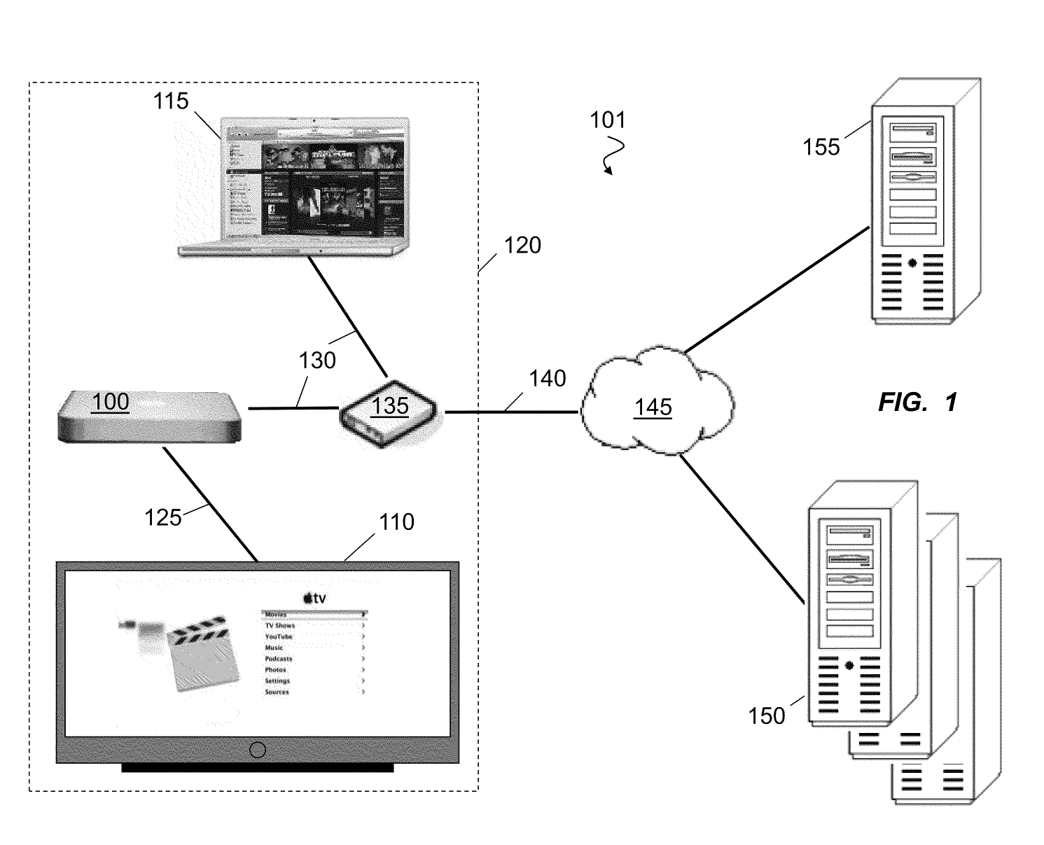

FIG. 1 shows a media system 101 that includes a media client 100, such as an Apple TV device, which can be configured to present media content, including audio, video, images, or any combination thereof, and to provide content-aware resources embodied, for example, as widgets displayed and made available to the TV viewer to enhance the TV viewing experience. The media system 101 includes a client location 120, such as a home or office, in which the media client 100 resides. The client location 120 also can include a local media server 115, such as a notebook computer executing an appropriate software application, and a presentation device, such as a TV set or monitor 110. The monitor 110 can be coupled to the media client 100 through a media connector 125, such that video and/or audio information output by the media client 100 can be presented through the monitor 110. Further, the media client 100 can be coupled to the local media server 115 through a local connection 130, such as either a wired or wireless network connection. As such, the media client 100 can receive media content from the local media server 115. The local media server 115 can be any suitable computing device, including a notebook or desktop computer, a server, a handheld device, or a media device capable of storing and/or playing back media content.

Further, the client location 120 can have a network connection 140 that provides access, via modem (or other network access device) 135 to a network 145, such as the Internet or another packet-switched network. By virtue of the network connection 140, the media client 100 and/or the local media server 115 can be configured to access media content from essentially any suitable media content provider connected to network 145, including for example a media store 155 such as the iTunes Store, media content providers 150 such as network and/or cable TV content providers (e.g., FOX, CBS, NBC, ABC, CNN or HBO) or websites (e.g., YouTube, Hulu) that make streaming or downloadable media content available over the Internet.

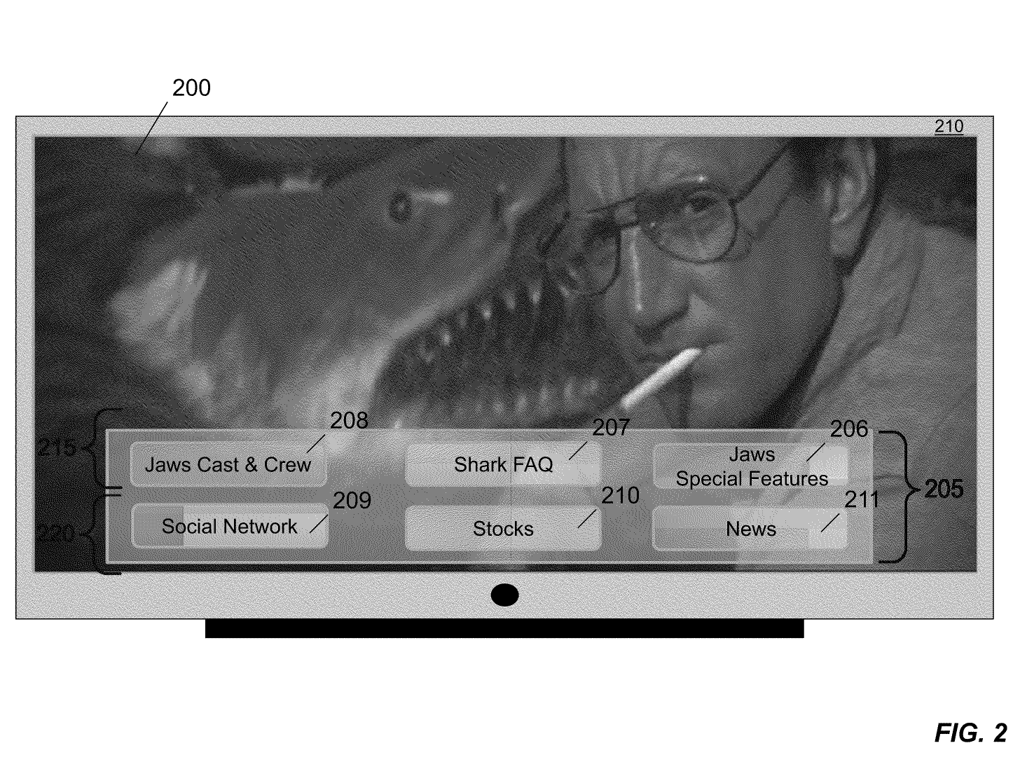

FIG. 2 depicts an example screen 200 of a media content presentation that is enhanced through the presence and use of content-aware widgets. In this example, the monitor 110 is presenting a primary item of media content, the movie “Jaws,” that occupies a majority of the screen 200. A widget area 205 is displayed on screen 200 in a manner that overlays the primary media content but, in this example, maintains a predetermined level of transparency such that portions of the primary media content that would otherwise be obscured by the widget area 205 remain visible. Arranged within the widget area is a quantity of individual widgets 206-211, in this example six, each of which represents a resource with which a user can interact to obtain information and/or achieve a particular functionality. Depending on implementation choices, the widget area 205 can, among other variable parameters, optionally appear elsewhere on the screen 200, can have a different shape, size, configuration and/or level of transparency, can accommodate a different number of widgets, and can disappear from view in response to a trigger (e.g., user choice, media content provider choice, TV set state, default condition, etc.).

In this example, the widget area is divided into two portions: a top portion 215 that is reserved for content-aware widgets and a bottom portion 220 that is reserved for user-customizable widgets. As shown, the top portion 215 includes three content-aware widgets: a “Jaws Cast & Crew” widget 208, a “Shark FAQ” widget 207, and a “Jaws Special Features” widget 206. These widgets appear automatically (i.e., without requiring intervening user input) at a time, location and choosing of a third party, for example, the media content provider that is broadcasting or otherwise making available the primary media content currently being presented—here, the movie Jaws.

As their respective names suggest, these three widgets 206-208 represent resources that are complementary, supplemental, relevant and/or related to the movie Jaws—the primary media content currently being presented. For example, the user can interact with the Jaws Cast & Crew widget 208 to obtain information about the people involved with making the movie currently being presented as the primary media content. This widget can be implemented, for example, by configuring the Jaws Cast & Crew widget 208 to link directly to the webpage on the Internet Movie Database (“IMDB”; www.imdb.com) that is dedicated to the movie Jaws. Accordingly, when the user manipulates an input device such as an infrared or RF remote control device (not shown) to move a cursor 225 to hover over and select the Jaws Cast & Crew widget 208, the media device 100, which receives and processes this input, will cause a new or different display, for example, a web browser window (not shown), to be presented on the monitor 110 to thereby provide the user with access to the IMDB webpage dedicated to the movie Jaws. Depending on design choices, this new display can be implemented as a sub-window (not shown) on screen 200 or can completely replace and occupy the entire screen 200 for as long as the user is interacting with the Jaws IMDB webpage.

The functionality and/or appearance of a content-aware widget can change as the primary media content progresses or otherwise changes. For example, the Jaws Cast & Crew widget 208 could be configured to react differently depending on what actors were presently being displayed on the screen 200. In the instant depicted in FIG. 2, only one (human) actor, namely, Roy Scheider, is currently being displayed on the screen 200. Accordingly, if the user at this frame or scene selects the Jaws Cast & Crew widget 208, the widget 208 could be configured to respond to provide resources relating specifically to Roy Scheider, for example, by bringing up the IMDB page dedicated to Roy Scheider, rather than the IMDB webpage dedicated to the movie Jaws in general. In addition, at a different point in time where a different actor from the movie Jaws appeared in the current scene, e.g., Robert Shaw, the Jaws Cast & Crew widget 208 could be configured to make resources available related to Robert Shaw, the actor in the scene being displayed at that time.

Similarly, the Shark FAQ widget 207 is aware of, and provides access to resources complementary to, the primary media content being presented in that the movie Jaws is about a large white shark wreaking havoc on a New England island resort town. In that regard, widget 207 represents a resource with which the user can interact to explore information about sharks, the central focus of the movie being presented. As another example, the Jaws Special Features widget 206 can be configured to provide the user with access to features that are complementary to the movie Jaws—the primary media content currently being presented. For example, activation of the Jaws Special Features widget 206 by the user could make a variety of complementary media items available to the user including, e.g., a video clip of an interview with Steven Spielberg (the director of Jaws) that is displayed alongside, or instead of, the movie Jaws itself.

Other variations of widget behavior can be implemented. For example, a widget can be configured to provide, and require, interaction with the user. In one such case, the viewing progress of primary media content can be controlled and/or altered by user interaction, for example, if the primary media content triggers the activation of a Jaws Trivia widget, which asks the user various trivia questions about the movie Jaws and, depending on the user's answer, will suspend presentation (e.g., until the user guesses correctly) and/or alter the subsequent presentation order depending on the user's answer (e.g., jumps to a scene in the movie that was the subject of the trivia question). As another example of interactivity, the primary media content presentation could activate a voting widget that allows the user to participate with others as an audience member of the same media content presentation. For example, while presenting a performance of a contestant on the FOX TV show American Idol, a widget could be activated at the conclusion of that performance to allow the user to vote on the quality of that performance.

The appearance of the particular choice widgets on the user's screen 200 in FIG. 2 is a direct result of the widgets' being content-aware—that is, a content-aware widget can present resources complementary to the primary media content because they were designed and/or specified by an entity having control over and/or knowledge of the identity of the primary media content currently being presented to the user. Typically this entity is the media content provider, for example, the TV broadcaster, cable operator, website operator, internet service provider and/or other third party that has at least some control over and/or responsibility for delivering the media content to the user's media client, which typically but not necessarily will occur via network connection 140 connected to packet-switched network 145.

Display, activation and/or availability of a content-aware widget need not be persistent during the entire primary media content presentation. Rather, the media content provider (and/or other third party having at least some knowledge of and/or control over the primary media content currently being presented to the user) can configure a content-aware widget so that it activates or is made available only in response to a particular trigger event, for example, the display of a predetermined key frame in a video presentation being viewed by the user. For example, in the example of FIG. 2, the media content provider could control the Shark FAQ widget 207 so that it first appears on screen 200 (and thus first made available to the user) when the first video frame containing an image of a shark is displayed on the user's screen 200. Similarly, the media content provider can cause a content-aware widget to deactivate, or change function, appearance or position on screen 200, or essentially any other parameter, in response to a detected trigger event. In addition to key frame detection, other possible trigger events, which generally are limited only by the creative design decisions made in implementing a content-aware widget system, include user input or external factors such as time of day, a weather event such as a storm, seasonal variations, special news alerts, commercial advertisements and the like.

Also as shown in FIG. 2, the bottom portion 220 is this example populated with three content-unaware widgets 209-211, namely, a social network widget 209 (e.g., Facebook or Twitter), a stock widget 210 through which the user can obtain stock related information, and a news widget 211 through which the user can obtain desired news information. The particular choice of widgets presented in the bottom portion 220 can be the result either of customized choices selected by the user and/or a default set of widgets selected by a third party, such as the TV set manufacturer or the Internet service provider. In addition, the bottom portion 220 need not be limited to content-aware widgets. Rather, depending on design and implementation choices, the user could be allowed to populate the bottom with one or more additional content-aware widgets that are made available by a third-party having knowledge of and/or control over the primary media content currently being presented on the user's screen 200. For example, user interface controls (not shown) could be made available to the user to provide access to a “widget store” or other collections of third-party developed widgets from the user can pick and install on the media device 100.

Essentially all of the parameters, configuration choices, proportions, graphical representations and the like shown in the particular example of FIG. 2 can vary according to desired design and implementation choices. For example, the primary media content can occupy more or less screen space than shown. The use of a widget area 205 and the constraint of individual widgets 206-211 to be within the widget area both are optional. Some implementations may constrain widgets to different portions of the screen 200 and/or allow the individual widget to appear anywhere on the screen, either by user selection or as controlled by the media content provider or other third party. In addition, the quantity of widgets displayed, their shape, color, transparency level and the like, as well as whether any particular widget space is reserved for content-aware widgets or user-selectable, all can be varied according to design preferences.

Content-aware widgets can be implemented as webpage files, for example, written in HTML, that are displayed as a separate display layer superimposed over the primary media content. Typically, a widget application would be written such that only a relatively small part of the webpage, which nominally is coextensive with the full screen 200, would be painted in with graphics that represent the widget and/or provide user interface abstractions for the user to interact with the widget. The large majority of a displayed widget webpage would be transparent so as not to obscure the primary media content, except in the relatively small area corresponding to the widget's graphical representation on the screen 200. In the example of FIG. 2, each of the six widgets 206-211 represents a separately displayable webpage overlay in which only the portion corresponding rectangle with rounded corners (which in this example are the widget's graphical representations) contain non-transparent pixel values. Generally speaking, widget creation and delivery can be implemented using any of several different standard and proprietary execution and/or layout formats including not only HTML but also Cascading Style Sheets (CSS), WebKit, native applications or the like.

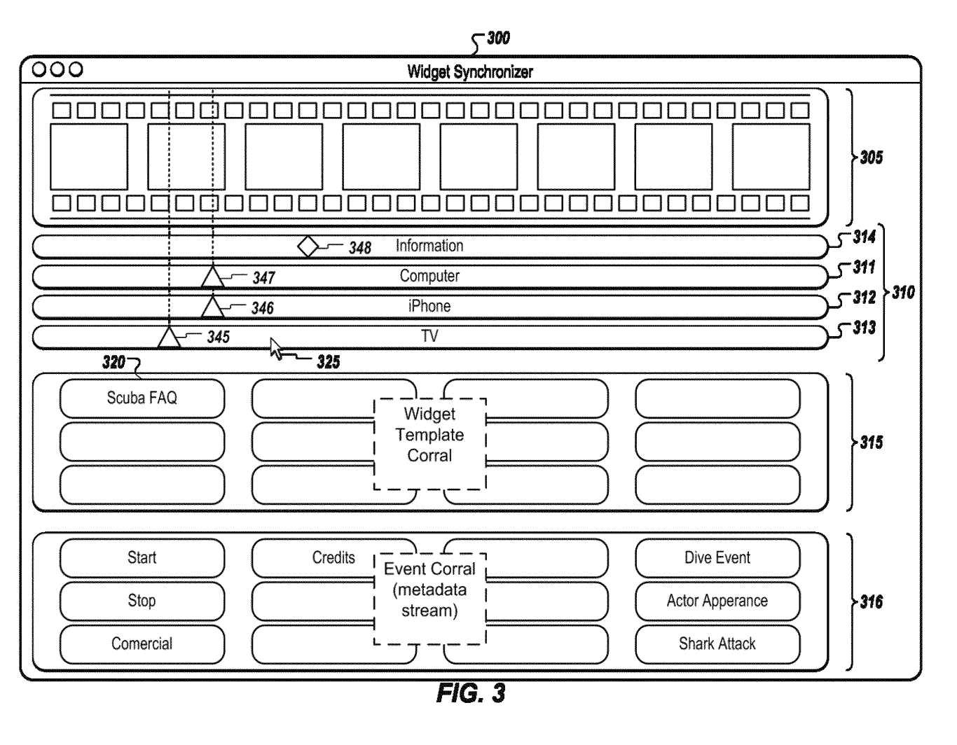

FIG. 3 is a mockup of an example graphical user interface that a media content provider could use to build an enhanced media content presentation in which, for example, a video clip having an associated audio track (e.g., a movie featuring scuba diving) is synchronized with various content-aware widgets, which when presented to a user, will provide that user with access to resources that are complementary to the media content item. As shown in FIG. 3, the “Widget Synchronizer” user interface window 300 is composed of four separate regions: a filmstrip region 305 in which a subset of frames of the media content item is displayed (and which can move forward or backward to gain access to other portions of the media content item), a timeline region 310 representing one or more master timelines for the media content item, a widget template corral 315, which represents a store of previously developed widget templates, and an Event Corral 316, which represents a store of different events (e.g., Start, Stop, Commercial, Credits) that can be associated with widget instances to control their timing and behaviors.

As shown in FIG. 3, the timeline region 310 includes three separate master timelines, one for each of three different destination presentation platforms: a Computer master timeline 311, an iPhone (or other mobile device) master timeline 312, and a TV master timeline 313. Multiple master timelines are provided to allow an operator to build an enhanced media content presentation that is tailored to the specific type of presentation platform on which the end user will experience the content. Providing this capability helps compensate for the fact that different types of destination platforms tend to have different characteristics (e.g., screen size, type of available input mechanisms, bandwidth, memory, storage, power requirements and the like) and thus different capabilities and limitations. Consequently, for a particular piece of multimedia content, an operator may want to specify a different selection of widgets, and/or different behaviors for those widgets, depending on the type of presentation device on which that content will be experienced.

The timeline region 310 also includes an information timeline 314. The information timeline 314 is provided to allow an operator to bind event metadata to the media content. An extensible set of tags are defined for a particular media type. For example, scene cut, actor appearance, and dive event tags can be defined for particular movie or other item of media content.

To synchronize a widget with the media content item for a particular destination presentation platform, an operator can manipulate the cursor 325 to grab a desired widget template from the Widget Template Corral 315 and place it at a position in the master timeline that corresponds to the destination presentation platform of interest and at a position in that timeline corresponding to a desired frame in the media content item. In the example shown in FIG. 3, the operator could use standard GUI techniques to grab the “Scuba FAQ” widget template, drag it to and drop it at a desired position on the TV Master Timeline 313, thereby indicating that an instance of the Scuba FAQ widget 320 is to appear on a viewer's screen, and thus become available to that viewer, at the point in time just after frame 340 is displayed on that viewer's TV screen.

As shown in FIG. 3, this action results in a widget control marker 345 (in this example, START, as represented by an upwards pointing triangle) appearing in the TV Master Timeline 313, thereby serving as graphical indicator that the Scuba FAQ widget 320 has been synchronized with the media content item such that it (widget 320) will become active at this viewing point at watch time on a TV platform (i.e., the time at which a viewer is watching the media content item on his or her TV set). As shown in the example of FIG. 3, the operator has specified analogous markers (also referred to as “tags”), but offset in time, at positions 346 and 347, respectively, in the iPhone Master Timeline 312 and Computer Master Timeline 311. The different positioning of markers 346 and 347 reflects customization choices made by the operator so that the widget timing and/or behaviors will differ if the media content is experienced on an iPhone or computer rather than on a TV set.

A widget control marker also can have other associated information such as the name and identity of the widget to which it corresponds, a location address (e.g., a URL or Uniform Resource Locator) on the Internet at which the associated widget resides, and the type of widget control operation it represents (e.g., start, stop, activate, deactivate, make visible, make invisible, change appearance, change function, change behavior, change position, or the like). To make them more readily understandable to a human operator, the widget control markers can take on different visual characteristics (e.g., shape, size or color) to indicate their respective marker types. For example, although not shown in the example of FIG. 3, the operator could use cursor manipulation techniques to place another Scuba FAQ widget control marker, perhaps a downwards facing triangle, specifying a point on the timeline 310 at which the instance of the Scuba FAQ widget that started (e.g., became visible and accessible to the user at watch time) at the frame 340, is to be stopped (e.g., deactivated and/or made invisible) at a viewing point several minutes later in the media content item.

To bind metadata to the media content, an operator can similarly manipulate the cursor 325 to grab a desired event from the event corral 316 and place it at a position in the information timeline 314 that corresponds to the event. This action results in an event marker 348 (in this example, Dive Event, as represented by a diamond) appearing in the information timeline 314, thereby serving as a graphical indicator that a dive event is identified in the media content item. Widgets in the master timelines can be programmed to respond to events in the information timeline 314. For example, the Scuba FAQ widget can flash and display a random question at each dive event.

Generally speaking, the Widget Synchronizer application shown in FIG. 3 would find primary applicability in synchronizing content-aware widgets to pre-recorded media, such as movies, TV shows and the like. Other synchronization tools and interfaces can be provided to enable media content providers (e.g., broadcasters) to insert content-aware widgets into a live, or slightly time-delayed, media content presentation, such as a live sporting event or the like.

For example, a broadcaster such as ESPN can create an information timeline for a live football game. An engineer can use a tablet computer displaying an alternative graphical user interface which displays a live feed of the football game, an event corral, and active widgets. The event corral is populated with tags for players in the game and in-game events such as a change of possession, first down, interception, etc. The objects in the event corral are coded by shape: player tags are circles and in-game events are squares.

When a player enters or leaves the field, the engineer drags that player's tag onto or off of the video feed, and when an in-game event occurs, the engineer drags the in-game event onto the video feed. For example, if a defensive player intercepts a pass, the engineer drags the interception in-game event onto the video feed, drags the defensive player events off of the video feed, and drags the offensive player events onto the feed.

The widgets to be displayed with a live event can be defined, in real time or ahead of time, based on the events and tags selected. For example, when the home team has the ball, as defined by every second change of possession event, an offensive stat widget is set to visible. When a change of possession event is dragged onto the video feed by the engineer to indicate the defense is now on the field, the offensive stat widget is set to not visible, and a defensive formation widget, which displays which personnel package is on the field, is set to visible.

The widgets and events themselves (e.g., those made available in widget template corral 315 and Event Corral 316) can be developed through standard programming techniques. Generally speaking, each content-aware widget represents a dedicated resource that can be made selectively available to viewers during media content playback. Typically, each widget is embodied as program code that defines that widget's appearance, functionality, behavior and the like. Optionally, some or all of the markers or tags specified by a broadcaster or publisher and embedded within an item of media content can be exposed or otherwise made accessible to the end user and/or the client device controlling the media presentation at playback time, so that the user (or client device) can perform actions or trigger visibility of desired widgets when the tagged events in the media stream occur.

Widgets and information streams can be created third parties. In the example of a live football broadcast, a website (e.g. Yahoo, NFL.com) that hosts fantasy football leagues can develop a fantasy football widget that displays information about a user's fantasy football team. The fantasy football widget uses the broadcaster information timeline to determine if any of the user's fantasy football players on currently in the game. When the broadcaster information timeline indicates one or more players in on the field, the fantasy football widget turns from gray to brown. When the broadcaster information timeline indicates an score, interception, sack, or other event worth fantasy points, the fantasy football widget blinks and displays the point value.

Alternatively or additionally, access to an information timeline can be sold. Continuing with the example of the live football broadcast, the broadcaster can sell access to the information timeline to the creator of a widget that advertises sports merchandise. When the merchandise widget detects a play by a player with a jersey or endorsed product sold by the widget creator, the widget changes its display to an ad for that jersey or endorsed product.

The broadcaster can also use the information timeline as part of a scheme to select commercials to show during the broadcast. If a player that endorses a product in a commercial makes a play during the game, the commercial can be queued to play during the next break.

Information streams can be created by third parties, for example to supplement existing information streams or to identify events for new widgets. For example, some movies generate a ‘cult following’ of fans who make call backs during the movie. A fan website can develop a widget that instructs a user to make the call backs at the correct time. The fan website can include a web-based interface, such as the user interface window 300, to allow fans to identify events in the movie for call backs. When the widget detects a call back event in the information timeline, it displays the call back instructions to the audience.

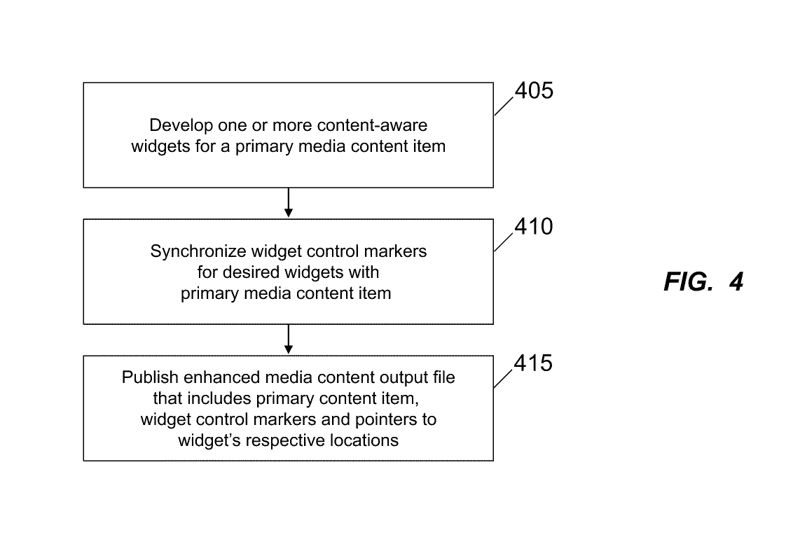

FIG. 4 is a flowchart of a process that a media content provider could use to build an enhanced media content presentation with synchronized content-aware widgets. The first step 405 in the process is the development of the content-aware widgets themselves. This step can be accomplished either by the media content provider creating new customized widgets for the particular media content item under consideration, re-using previously developed widgets that find applicability and relevance across several different items of media content and/or obtaining widgets from third parties, such as business partners, advertisers, and the like.

Next, at step 410, an operator working for the media content provider uses a tool such as the Widget Synchronizer shown in FIG. 3 to synchronize content-aware widgets with the item of media content. Finally, at step 415, the media content provider publishes the final product, namely an output file that encapsulates the media content to be presented along with widget control markers specifying the behavior and timing of widgets that will be made available during presentation of the media content item. In one implementation, the final output file can be in a multimedia container format that is similar to and/or an extension of existing formats such MPEG-4, 3GP, DivX, Ogg, VOB or equivalent, but which has been designed or modified to accommodate inclusion of the widget control markers that specify widget behavior and timing. In any event, the final output file need not, and typically will not, encapsulate executable instances of the widgets themselves but rather will specify URLs or other pointers to the appropriate widgets when they are to be invoked or used.

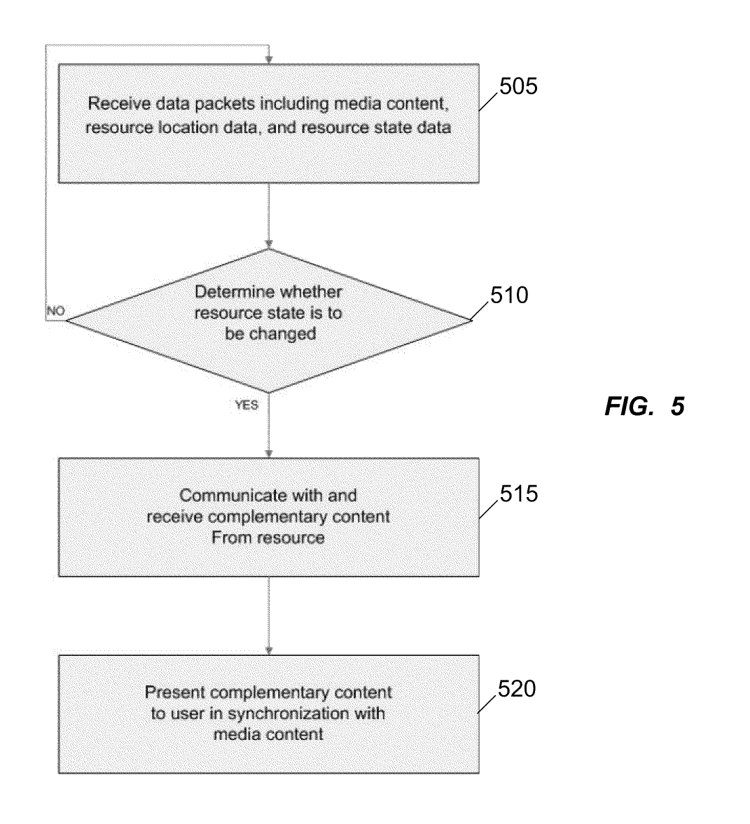

FIG. 5 is a flowchart of a process, performed at watch time, for using content-aware widgets to present complementary resources to a viewer in synchronization with presentation of media content. This process can be performed and/or controlled by any of a number of different controllers, or a combination of two or more. For example, the process of FIG. 5 could be performed primarily by media client 100 by receiving the needed data over the Internet 145, directly or indirectly, from a media content provider 150. Because the local media server 115 also has communication connectivity with the media client 100 and the Internet 145, it too can be involved in some or all of the process control. Alternatively, or in addition, the server 155 hosting the media store also can participate in the control and delivery of enhanced media presentations having embedded complementary resources. For example, the server 155 may act as an aggregator and control point for enhanced media presentations based on contractual arrangements with media content developers and/or other third parties.

In any event, as the first step in the process of FIG. 5, the media client 100 (which is controlling the process in this example, but need not necessary as discussed above) receives via the Internet data packets that include at least three different types of information corresponding to the three types of information encapsulated in the final output file generated by the media content provider as discussed above. These three types of information include (i) primary media content (e.g., a movie having video and audio tracks) for presentation to a user who is viewing monitor 110. The received data packets also include (ii) location data (e.g., a URL) specifying a resource that is complementary to the primary media content being presented. This resource is displayed, and otherwise made available to the user, as a widget selectively displayed on monitor 110 at an appropriate time during presentation of the primary media content. Last but not least, the received data packets also include (iii) state data relating to a state of the complementary resource.

As the next step of the process of FIG. 5, the media client 100 uses the received state data to communicate with the widget to which it relates to selectively change the state (of, if indicated, not to change the state) of that widget during presentation of the primary media content. Examples of widget states include stop/start, activate/deactivate, change appearance, change function, change location on screen, and the like. If the received state data includes no indication that the widget's state is to be changed, the process returns step 505 to receive more packets of data. (Of course, even if no widget state change is to be performed, the received primary media content is passed to the monitor 110 and used to update the screen display, as appropriate.)

On the other hand, if the received state data indicates that the time for a widget state change has come, the media client 100 communicates with the resource corresponding to the widget under consideration to effect the instructed state change. Depending on the type of state change instructed, the widget may return complementary video and/or audio content, along with instructions to the media client 100 for presentation of same. In response, the media client 100 formats the received complementary content along with the primary media content and passes the formatted media content onto the monitor 110 for presentation to the user.

Although not shown in FIG. 5, the media controller also can receive input from the user via the monitor 110's remote control device. For example, the user might select an available widget and make a request for information or other content. In that case, the media center 110 communicates the user input to the resource corresponding to the widget in question to retrieve the requested and pass it back to monitor 110 for presentation to the user. As another example, the tags that the broadcaster or publisher assigns to the timeline while building the enhanced media content can be made accessible to the end user (and/or to the media device) at playback time so that the user (and/or the media device itself without user input) can perform actions or trigger visibility of widgets as desired when tagged events in the stream occur.

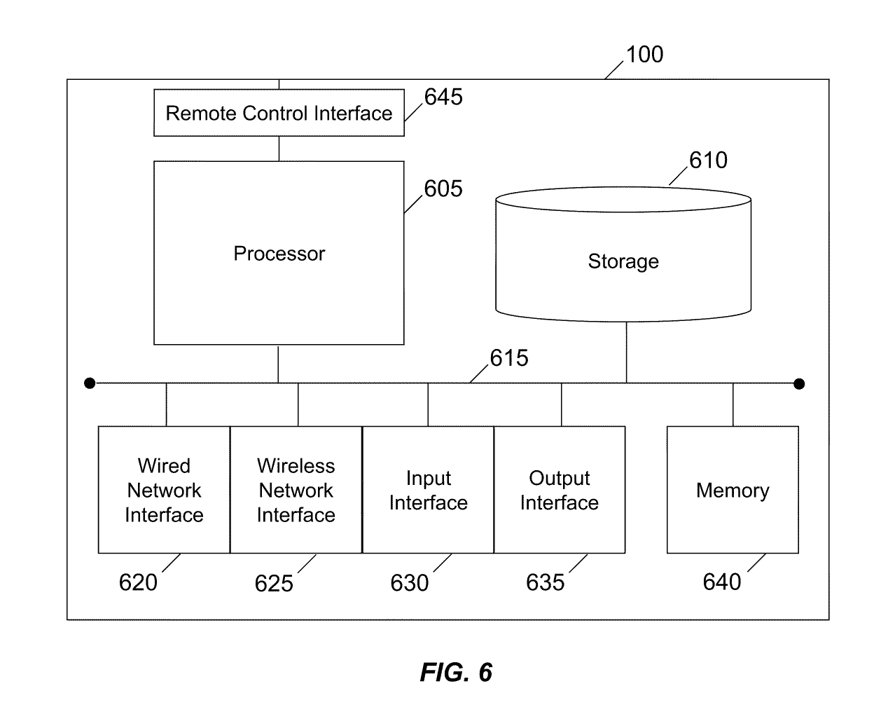

FIG. 6 depicts an exemplary architecture of the media client 100, which includes a processor 605 configured to control the operation of the media client 100. For example, the processor 605 can control communications with one or more media servers to receive media for playback. A media server can be any general purpose server that provides access to media content. The media can be received through push and/or pull operations, including through downloading and streaming. The processor 605 also can be configured to generate output signals for presentation, such as one or more streams representing media content or an interface for interacting with a user.

The media client 100 also includes a storage device 610 that can be configured to store information including media, configuration data, user preferences, and operating instructions. The storage device 610 can be any type of non-volatile storage, including a hard disk device or a solid-state drive. For example, media received from an external media server can be stored on the storage device 610. The received media thus can be locally accessed and processed. Further, configuration information, such as the resolution of a coupled display device or information identifying an associated media server, can be stored on the storage device 610. Additionally, the storage device 610 can include one or more sets of operating instructions that can be executed by the processor 605 to control operation of the media client 100. In an implementation, the storage device 610 further can be divided into a plurality of partitions, wherein each partition can be utilized to store one or more types of information. Additionally, each partition can have one or more access control provisions.

A communication bus 615 couples the processor 605 to the other components and interfaces included in the media client 100. The communication bus 615 can be configured to permit unidirectional and/or bidirectional communication between the components and interfaces. For example, the processor 605 can retrieve information from and transmit information to the storage device 610 over the communication bus 615. In an implementation, the communication bus 615 can be comprised of a plurality of busses, each of which couples at least one component or interface of the media client 100 with another component or interface.

The media client 100 also includes a plurality of input and output interfaces for communicating with other devices, including media servers and presentation devices. A wired network interface 620 and/or a wireless network interface 625 each can be configured to permit the media client 100 to transmit and receive information over a network, such as a local area network (LAN) or the Internet, thereby enabling either wired and/or wireless connectivity and data transfer. Additionally, an input interface 630 can be configured to receive input from another device through a direct connection, such as a USB, eSATA or an IEEE 1394 connection.

Further, an output interface 635 can be configured to couple the media client 100 to one or more external devices, including a television, a monitor, an audio receiver, and one or more speakers. For example, the output interface 635 can include one or more of an optical audio interface, an RCA connector interface, a component video interface, and a High-Definition Multimedia Interface (HDMI). The output interface 635 also can be configured to provide one signal, such as an audio stream, to a first device and another signal, such as a video stream, to a second device. Further, a non-volatile memory 640, such as a read-only memory (ROM) also can be included in the media client 100. The non-volatile memory 640 can be used to store configuration data, additional instructions, such as one or more operating instructions, and values, such as one or more flags and counters. In an implementation, a random access memory (RAM) also can be included in the media client 100. The RAM can be used to store media content received in the media client 100, such as during playback or while the user has paused playback. Further, media content can be stored in the RAM whether or not the media content is stored on the storage device 610.

Additionally, the media client 100 can include a remote control interface 645 that can be configured to receive commands from one or more remote control devices (not pictured). The remote control interface 645 can receive the commands through wireless signals, such as infrared and radio frequency signals. The received commands can be utilized, such as by the processor 605, to control media playback or to configure the media client 100. In an implementation, the media client 100 can be configured to receive commands from a user through a touch screen interface. The media client 100 also can be configured to receive commands through one or more other input devices, including a keyboard, a keypad, a touch pad, a voice command system, and a mouse.

A number of implementations have been disclosed herein. Nevertheless, it will be understood that various modifications may be made without departing from the spirit and scope of the claims. Accordingly, other implementations are within the scope of the following claims.

What is claimed is:

1. A method performed by a computer system, the method comprising:
receiving data packets via a packet-switched network, the received data packets including (i) media content for presentation to a user, (ii) location data specifying a resource that is complementary to the media content, and (iii) state data relating to a state of the complementary resource;
determining, based at least in part on the received state data, whether the state of the complementary resource is to be changed; and
based at least in part on a result of the determination, selectively performing operations including:
using the received location data to communicate with, and retrieve complementary content from, the complementary resource; and
presenting the complementary content to the user in synchronization with the media content.

2. The method of claim 1 further comprising:
receiving input from the user relating to a requested interaction with the complementary resource;
delivering the received input to the complementary resource;
receiving information from the complementary resource responsive to the received user input; and
presenting the received information to the user.

3. The method of claim 1 further comprising:
receiving input from user specifying a second resource of the user's choosing;
retrieving second content from the second resource based on location information corresponding to the second resource;
formatting the retrieved second content relative to the media content and relative to the complementary content; and
presenting the formatted second content, complementary resource and media content to the user.

4. The method of claim 1 wherein the state data corresponds to one or more of the following states: visibility/invisibility, activate/deactivate, change functionality, change appearance, and change position.

5. The method of claim 1 wherein presenting the received information to the user comprises formatting the received information based on an output device with which the user is accessing the media content.

6. The method of claim 1 wherein the received data packets further include one or more markers identifying one or more events that trigger communication with the complementary resource or the user or both.

7. The method of claim 6 further comprising presenting the one or more markers to the user and enabling the user to interact with the tags to alter one or more of timing, behavior and complementary content.

8. The method of claim 1 further comprising providing the user with one or more user interface mechanisms to enable the user to modify behavior of a complementary resource.

9. The method of claim 1 further comprising providing the user with one or more user interface mechanisms to enable the user to access an online repository of complementary resources available for download.

10. The method of claim 1 further comprising providing the user with one or more user interface mechanisms to enable the user to generate complementary resources.

11. An enhanced media content development system comprising:
a computer system including a processor, memory, and input and output devices;
an application configured to execute on the computer system to enable a user of the computer system to build an item of enhanced media content by specifying complementary resources that will be presented to an audience member along with an item of primary media content;
wherein the application includes a user interface configured to provide a user of the enhanced media content development system with mechanisms to synchronize one or more complementary resources with corresponding portions of the item of primary media content; and
wherein the application is configured to generate an enhanced media file that includes the primary media content and metadata specifying locations at which the one or more complementary resources are to be accessed by a media presentation device when the corresponding portions of the primary media content item are being presented to the audience member.

12. The system of claim 11 wherein the user interface is further configured to provide the user of the enhanced content development system with one or more mechanisms to synchronize one or more events with corresponding portions of the item of primary media content.

13. The system of claim 11 wherein the user interface comprises a film strip region that provides the user with access to the primary media content item, a complementary resource region that provides the user with access to one or more complementary resources available for synchronization with the primary media content item and a timeline region that enables the user to synchronize one or more of the complementary resources with corresponding portions of the item of primary media content.

14. The system of claim 13 further comprising an event region that provides the user with access to one or more events available for synchronization with the primary media content item

15. The system of claim 13 wherein the timeline region includes a plurality of individual timelines each of which corresponds to a different presentation platform for which the enhanced media file is optimized.

16. A computer program product, tangibly embodied in an information carrier, the computer program product comprising instructions operable to cause data processing apparatus to perform operations comprising:
receiving data packets via a packet-switched network, the received data packets including (i) media content for presentation to a user, (ii) location data specifying a resource that is complementary to the media content, and (iii) state data relating to a state of the complementary resource;
determining, based at least in part on the received state data, whether the state of the complementary resource is to be changed; and
based at least in part on a result of the determination, selectively performing operations including:
using the received location data to communicate with, and retrieve complementary content from, the complementary resource; and
presenting the complementary content to the user in synchronization with the media content.

17. The computer program product of claim 16 further comprising instructions operable to cause data processing apparatus to perform operations comprising:
receiving input from the user relating to a requested interaction with the complementary resource;
delivering the received input to the complementary resource;
receiving information from the complementary resource responsive to the received user input; and
presenting the received information to the user.

18. The computer program product of claim 16 further comprising instructions operable to cause data processing apparatus to perform operations comprising:
receiving input from user specifying a second resource of the user's choosing;
retrieving second content from the second resource based on location information corresponding to the second resource;
formatting the retrieved second content relative to the media content and relative to the complementary content; and
presenting the formatted second content, complementary resource and media content to the user.

19. The computer program product of claim 16 wherein the state data corresponds to one or more of the following states: visibility/invisibility, activate/deactivate, change functionality, change appearance, and change position.

20. The computer program product of claim 16 wherein presenting the received information to the user comprises formatting the received information based on an output device with which the user is accessing the media content.

21. The computer program product of claim 16 wherein the received data packets further include one or more markers identifying one or more events that trigger communication with the complementary resource or the user or both.

22. The computer program product of claim 21 further comprising instructions operable to cause data processing apparatus to perform operations comprising presenting the one or more markers to the user and enabling the user to interact with the tags to alter one or more of timing, behavior and complementary content.

23. The computer program product of claim 16 further comprising instructions operable to cause data processing apparatus to perform operations comprising providing the user with one or more user interface mechanisms to enable the user to modify behavior of a complementary resource.

24. The computer program product of claim 16 further comprising instructions operable to cause data processing apparatus to perform operations comprising providing the user with one or more user interface mechanisms to enable the user to access an online repository of complementary resources available for download.

25. The computer program product of claim 16 further comprising instructions operable to cause data processing apparatus to perform operations comprising providing the user with one or more user interface mechanisms to enable the user to generate complementary resources.
